(19) United States
(12) Patent Application Publication
(10) Pub. No.: US 2012/0316810 A1
(43) Pub. Date: Dec. 13, 2012

(54) BATTERY LIMIT CALIBRATION BASED ON BATTERY LIFE AND PERFORMANCE OPTIMIZATION

(75) Inventors: Asif A. SYED, Canton, MI (US); Sudhakar INGUVA, Troy, MI (US); Joseph M. LOGRASSO, Troy, MI (US); Christopher R. NEUMAN, Royal Oak, MI (US); Ryan B. MOULLIET, Farmington Hills, MI (US)

(73) Assignee: GM GLOBAL TECHNOLOGY OPERATIONS LLC, DETROIT, MI (US)

(21) Appl. No.: 13/156,259

(22) Filed: Jun. 8, 2011

(51) Int. Cl. G06F 19/00

(52) U.S. Cl. 702/63; 702/85

(57) ABSTRACT

Methods and systems are provided for calibrating one or more limits of a battery of a vehicle, the battery having state of charge limits and power limits. A history of environmental conditions for the vehicle is obtained and stored in a memory. One or more of the state of charge limits, one or more of the power limits, or both are adjusted based on the history of environmental conditions and usage severity using a processor.

### TECHNICAL FIELD

The present disclosure generally relates to the field of vehicle batteries and, more specifically, to methods and systems for calibrating state of charge and/or power limits for batteries of vehicles, such as in electric or hybrid electric vehicles.

### BACKGROUND

Certain vehicles, particularly electric vehicles and hybrid electric vehicles, utilize batteries (e.g., battery packs) for power. The battery includes various battery cells within. The battery typically operates within state of charge and power limits that are pre-set for the vehicle. The state of charge and power limits are typically pre-set based on a worst case scenario of environmental and operating conditions, in order to ensure longevity of the battery across all conditions. However, in certain cases such typical techniques may not provide optimal battery performance or fuel savings for the vehicle, for example in relatively mild climates or mild usage conditions.

Accordingly, it is desirable to provide improved methods for calibrating state of charge or power limits for batteries, such as for hybrid vehicles or hybrid electric vehicles. It is also desirable to provide improved program products and systems for calibrating state of charge or power limits for batteries, such as for hybrid vehicles or hybrid electric vehicles. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided for calibrating limits of a battery of a vehicle, the battery having state of charge limits and power limits. The method comprises the steps of obtaining a history of environmental conditions for the vehicle, and adjusting one or more of the state of charge limits, one or more of the power limits, or both based on the history of environmental conditions and usage severity pertaining to chemistry failure modes using a processor.

In accordance with another exemplary embodiment, a program product is provided for calibrating limits of a battery of a vehicle, the battery having state of charge limits and power limits. The program product comprises a program and a non-transitory, computer-readable storage medium. The program is configured to obtain a history of environmental conditions for the vehicle, and adjust one or more of the state of charge limits, one or more of the power limits, or both based on the history of environmental conditions. The non-transitory, computer-readable storage medium bears the program.

In accordance with a further exemplary embodiment, a system is provided for calibrating limits of a battery of vehicle, the battery having state of charge limits and power limits. The system comprises a memory and a processor. The memory is configured to store a history of environmental conditions for the vehicle. The processor is coupled to the memory, and is configured to adjust one or more of the state of charge limits, one or more of the power limits, or both based on the history of environmental conditions.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of a vehicle, such as an electric vehicle or a hybrid electric vehicle, including a battery and a system for adjusting state of charge and power limits for the battery, in accordance with an exemplary embodiment;

FIG. 2 is a flowchart of a process for adjusting state of charge and power limits for a battery of a vehicle, such as the battery of the vehicle of FIG. 1, and that can be used in conjunction with the system of FIG. 1, in accordance with an exemplary embodiment;

FIG. 3 is a flowchart of a sub-process of the process of FIG. 2, namely, a sub-process for estimating a current capacity of the battery, in accordance with an exemplary embodiment;

FIG. 4 is a flowchart of a sub-process of the process of FIG. 2, namely, a sub-process for modifying upper and lower state of charge limit curves for the battery, in accordance with an exemplary embodiment;

FIG. 5 is a flowchart of a sub-process of the process of FIG. 2, namely, a sub-process for modifying upper and lower state of charge limit curves for the battery, in accordance with an exemplary embodiment;

FIG. 6 includes graphical representations of exemplary capacity curves and capacity limit curves that may be utilized in connection with the process of FIG. 2, the sub-processes of FIGS. 2-5, and the system of FIG. 1, in accordance with an exemplary embodiment; and

FIG. 7 includes graphical representations of exemplary resistance curves and resistance limit curves that may be utilized in connection with the process of FIG. 2, the sub-processes of FIGS. 2-5, and the system of FIG. 1, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

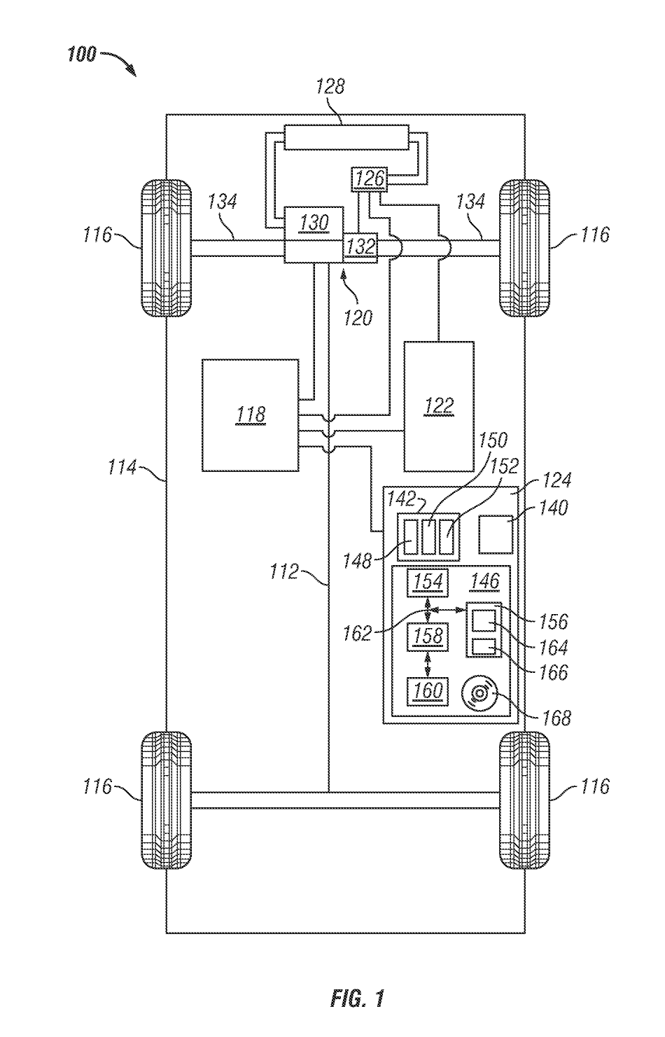

FIG. 1 illustrates a vehicle 100, or automobile, according to an exemplary embodiment. As described in greater detail further below, the vehicle 100 is configured to adjust state of power limits for a battery 122 of the vehicle based on environmental conditions and usage severity, such as average temperature values of geographic locations in which the vehicle has been operated over a period of time.

The vehicle 100 includes a chassis 112, a body 114, four wheels 116, and an electronic control system 118. The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114.

The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of engines, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, a fuel cell and an electric motor.

In the exemplary embodiment illustrated in FIG. 1, the vehicle 100 is a hybrid electric vehicle (HEV), and further includes an actuator assembly 120, the above-referenced battery 122, a battery control system 124, a power inverter assembly (or inverter) 126, and a radiator 128. The actuator assembly 120 includes a combustion engine 130 and an electric motor/generator (or motor) 132. As will be appreciated by one skilled in the art, the electric motor 132 includes a transmission therein, and although not illustrated also includes a stator assembly (including conductive coils), a rotor assembly (including a ferromagnetic core), and a cooling fluid (i.e., coolant). The stator assembly and/or the rotor assembly within the electric motor 132 may include multiple electromagnetic poles (e.g., sixteen poles), as is commonly understood.

Still referring to FIG. 1, the combustion engine 130 and the electric motor 132 are integrated such that one or both are mechanically coupled to at least some of the wheels 116 through one or more drive shafts 134. In one embodiment, the vehicle 100 is a “series HEV,” in which the combustion engine 130 is not directly coupled to the transmission, but coupled to a generator (not shown), which is used to power the electric motor 132. In another embodiment, the vehicle 100 is a “parallel HEV,” in which the combustion engine 130 is directly coupled to the transmission by, for example, having the rotor of the electric motor 132 rotationally coupled to the drive shaft of the combustion engine 130.

The battery 122 is electrically connected to the inverter 126. In one embodiment, the battery 122 comprises a set of battery cells which can be made of various chemistries and with a combination of various anode and cathode materials, such as a lithium ion battery. The battery 122 operates within upper and lower state of charge and power limits provided by the battery control system 124, described below.

As depicted in FIG. 1, the battery control system includes a global positioning system (GPS) device 140, a sensor array 168, and a controller 146. The GPS device 140 receives information pertaining to the geographic location of the vehicle over time (preferably as the vehicle is driven, for example one or more satellite communication connections), and provides information as to the resulting geographic locations to the controller 146.

The sensor array 168 includes temperature sensor 148, a current sensor 150, and a voltage sensor 152. Each of the sensors 148, 150, and 152 are preferably disposed adjacent or proximate to the battery 122. The temperature sensor 148 measures an ambient temperature outside (preferably, adjacent to) the battery 122, and provides signals and/or information thereto to the controller 146 for processing and for use in adjusting state of charge and power limits for the battery 122. The current sensor 150 measures an electric current of the battery 122, and provides signals and/or information thereto to the controller 146 for processing and for use in adjusting state of charge and power limits for the battery 122. The voltage sensor 152 measures a voltage of the battery 122, and provides signals and/or information thereto to the controller 146 for processing and for use in adjusting state of charge and power limits for the battery 122.

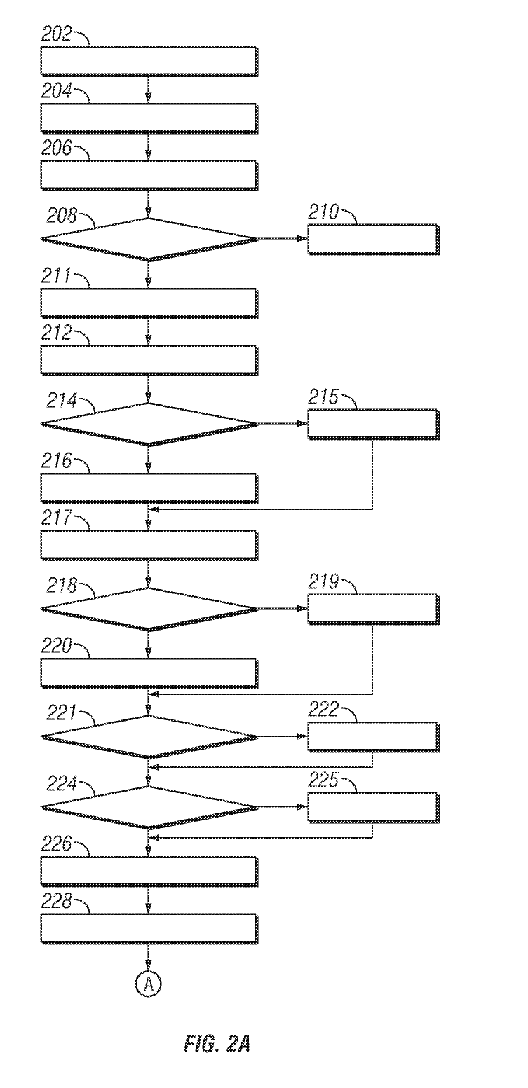

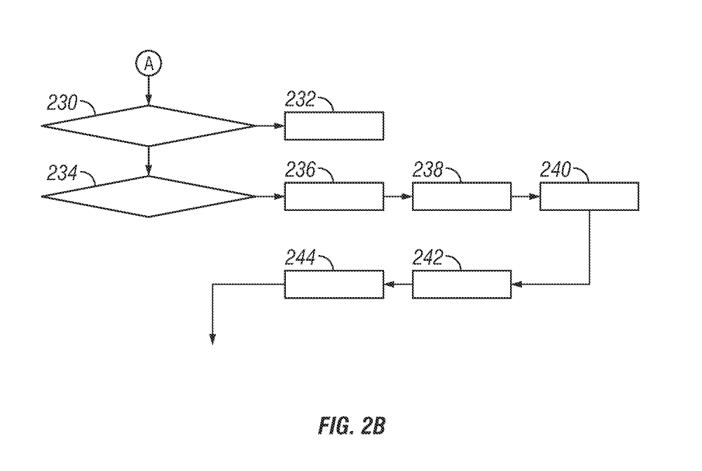

The controller 146 is coupled to the GPS device 140, the sensor array 168, the battery 122, and the electronic control system 118. The controller 146 utilizes the geographic data location data from the GPS device 140 and the measured values from the sensor array 168 in determining state of charge and power limits and adjustments thereto for the battery 122 based on environmental conditions and usage severity for the battery 122 and/or for the vehicle 100, preferably including average temperature values for the geographic locations in which the vehicle 100 has been driver. In a preferred embodiment, the controller 146 performs these functions in accordance with steps of the process 200 and the sub-processes thereof described further below in connection with FIGS. 2-6.

In certain embodiments, the controller 146 directly controls the state of charge and power limits for the battery 122. In certain other embodiments, the controller 146 indirectly controls the state of charge and power limits for the battery 122 via instructions and/or information provided to the electronic control system 118. In addition, although not illustrated as such, the battery control system 124 (and/or one or more components thereof) may be integral with the electronic control system 118 and may also include one or more power sources.

As depicted in FIG. 1, the controller 146 comprises a computer system. In certain embodiments, the controller 146 may also include one or more of the sensors 148, 150, 152, the GPS device 140, the electronic control system 118 and/or portions thereof, and/or one or more other devices. In addition, it will be appreciated that the controller 146 may otherwise differ from the embodiment depicted in FIG. 1. For example, the controller 146 may be coupled to or may otherwise utilize one or more remote computer systems and/or other control systems.

In the depicted embodiment, the computer system of the controller 146 includes a processor 154, a memory 156, an interface 158, a storage device 160, and a bus 162. The processor 154 performs the computation and control functions of the controller 146, and may comprise any type of processor or multiple processors, single integrated circuits such as a microprocessor, or any suitable number of integrated circuit devices and/or circuit boards working in cooperation to accomplish the functions of a processing unit. During operation, the processor 154 executes one or more programs 164 contained within the memory 156 and, as such, controls the general operation of the controller 146 and the computer system of the controller 146, preferably in executing the steps of the processes described herein, such as the steps of the process 200 and the various steps, sub-processes, and graphical illustrations pertaining thereto in FIG. 2, described further below.

The memory 156 can be any type of suitable memory. This would include the various types of dynamic random access memory (DRAM) such as SDRAM, the various types of static RAM (SRAM), and the various types of non-volatile memory (PROM, EPROM, and flash). The bus 162 serves to transmit programs, data, status and other information or signals between the various components of the computer system of the controller 146. In a preferred embodiment, the memory 156 stores the above-referenced program 164 along with one or more stored values 166, include various databases of information pertaining to temperature values and/or other environmental conditions of various geographic locations in which the vehicle may have been operated over time. In certain examples, the memory 156 is located on and/or co-located on the same computer chip as the processor 154.

The interface 158 allows communication to the computer system of the controller 146, for example from a system driver and/or another computer system, and can be implemented using any suitable method and apparatus. It can include one or more network interfaces to communicate with other systems or components. The interface 158 may also include one or more network interfaces to communicate with technicians, and/or one or more storage interfaces to connect to storage apparatuses, such as the storage device 160.

The storage device 160 can be any suitable type of storage apparatus, including direct access storage devices such as hard disk drives, flash systems, floppy disk drives and optical disk drives. In one exemplary embodiment, the storage device 160 comprises a program product from which memory 156 can receive a program 164 that executes one or more embodiments of one or more processes of the present disclosure, such as the steps of the process 200 and the various steps, sub-processes, and graphical illustrations pertaining thereto in FIG. 2, described further below. In another exemplary embodiment, the program product may be directly stored in and/or otherwise accessed by the memory 156 and/or a disk (e.g. disk 168), such as that referenced below.

The bus 162 can be any suitable physical or logical means of connecting computer systems and components. This includes, but is not limited to, direct hard-wired connections, fiber optics, infrared and wireless bus technologies. During operation, the program 164 is stored in the memory 156 and executed by the processor 154.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 154) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system of the controller 146 may also otherwise differ from the embodiment depicted in FIG. 1, for example in that the computer system of the controller 146 may be coupled to or may otherwise utilize one or more remote computer systems and/or other control systems.

The radiator 128 is connected to the frame at an outer portion thereof and although not illustrated in detail, includes multiple cooling channels therein that contain a cooling fluid (i.e., coolant) such as water and/or ethylene glycol (i.e., “antifreeze”) and is coupled to the engine 130 and the inverter 126.

FIG. 2 is a flowchart of a process 200 for adjusting state of charge and power limits for a battery of a vehicle, such as an electric vehicle or a hybrid electric vehicle, in accordance with an exemplary embodiment. The process 200 can be utilized in connection with the vehicle 100, the battery 112, and the battery control system 124, and/or various components thereof, in accordance with an exemplary embodiment.

As depicted in FIG. 2, the process 200 begins after a predetermined number of days or ignition cycles for the vehicle (step 202). Various data inputs are obtained (step 204). The data inputs preferably include time averaged values of various parameters pertaining to the battery, such as ambient temperature near the battery, an RMS power, the state of charge, the state of charge swing, the duty cycle and other factors that affect battery degradation. In addition, the data inputs preferably include measured capacity and resistance of the battery, default state of charge values, the current state of charge upper limit, the current state of charge lower limit, the state of charge setpoint, the power upper limit, and the power lower limit of the battery, a state of charge of the battery, a state of charge swing of the battery, and a duty cycle of the battery. The data inputs are preferably stored in the memory 156 of FIG. 1 as stored values 166 thereof after being measured by the sensor array 142 of FIG. 1 and/or calculated by the processor 154 of FIG. 1 based on measured values obtained by the sensor array 142 of FIG. 1.

One or more geographic locations are identified or obtained (step 206). In one embodiment, the geographic location comprises a geographic region in which the vehicle was purchased, and is stored in the memory 156 of FIG. 1 for use by the processor 154 of FIG. 1. In another embodiment, the geographic locations comprise one or more geographic regions in which the vehicle has been operated, preferably as identified or obtained by the GPS device 140 of FIG. 1 and provided to the processor 154 of FIG. 1. In yet another embodiment, temperature characteristics of the geographic region are determined by the processor 154 of FIG. 1 based on temperature measurements obtained from the temperature sensor 148 of FIG. 1. In still other embodiments, a combination of two or more such identifications of the geographic region may be utilized.

A determination is made as to whether the geographic location represents a high temperature environment (step 208). In a preferred embodiment, a geographic location is determined to represent a high temperature environment if it approximately matches the distribution of a high temperature climate as defined by the algorithm, such as Phoenix, Ariz. This determination is preferably made by the processor 154 of FIG. 1.

If it is determined that the geographic location represents a high temperature environment, then the state of charge and power limits for the battery remain at a relatively conservative level (step 210). Specifically, in this case, the upper and lower state of charge and power limits remain at respective first levels (preferably, factory pre-set levels) that provide for battery life to extend for a predetermined target amount of time under a “worst case scenario” (i.e., assuming relatively high temperature values and/or other potentially adverse weather conditions). The process also preferably exits during step 210. The state of charge determination and implementation of step 210 (i.e., the maintenance of existing or factory pre-set levels) is preferably performed by the processor 154 of FIG. 1.

If the geographic location does not represent a high temperature environment, then a battery life lower limit model or curve is obtained for capacity and a battery life upper limit model or curve is obtained for resistance (step 211). The battery life lower limit model or curve and the battery life upper limit model or curve preferably represent an estimated or projected amount of battery degradation over time that is expected with a relatively high degree of certainty (e.g., with a ninety percent confidence interval) under various conditions pertaining to the environment (such as temperature) and usage severity (such as various state of charge related variables). The battery life lower limit model or curve and the battery life upper limit model or curve are preferably stored in the memory 156 of FIG. 1 as stored values 166 thereof and retrieved by the processor 154 of FIG. 1.

A current capacity and resistance for the battery are then estimated (step 212). Specifically, in a preferred embodiment, the current capacity and resistance are estimated by the processor 154 of FIG. 1 during step 212 using the battery life model.

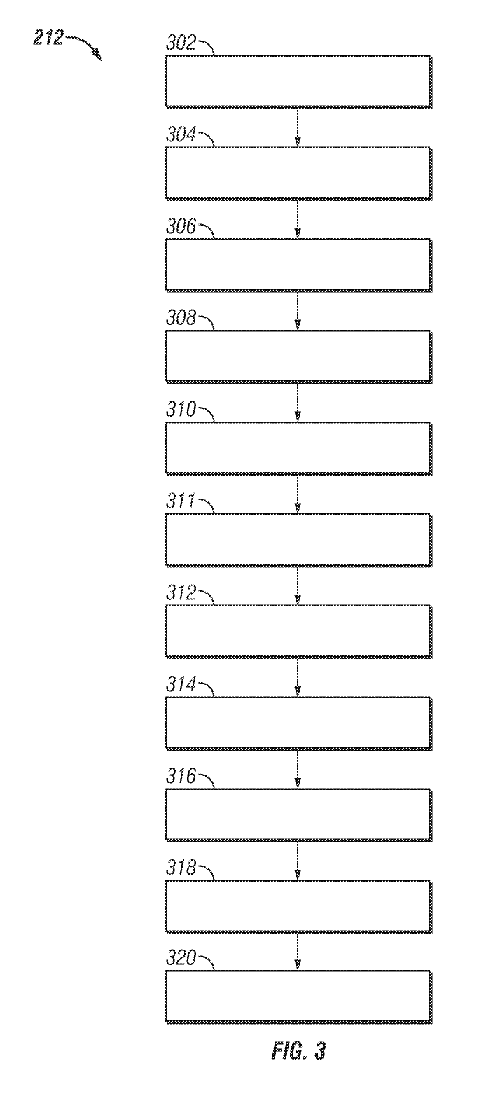

With reference to FIG. 3, steps are provided for a sub-process for step 212 (estimating the current capacity and resistance for the battery), in accordance with an exemplary embodiment. An average value of state of charge setpoint is calculated, preferably corresponding to an average setpoint of state of charge over various ignition cycles over time (step 302). An average value of state of charge swing is also calculated, preferably corresponding to an average swing of state of charge between various ignition cycles over time (step 304). In addition, a region based temperature distribution (step 306) is also calculated or determined, preferably corresponding to an average temperature value for the geographic location or region identified in step 206 above.

The average values of steps 302 and 304 are preferably calculated by the processor 154 of FIG. 1 based on measurements provided thereto by the sensor array 142 of FIG. 1 (preferably from current and/or voltage values measured by one or more of the sensors 150, 152 of FIG. 1). In one embodiment, the temperature distribution (and/or average temperature values) of step 306 is calculated or otherwise determined by the processor 154 of FIG. 1 based on temperature values associated with the geographic location data obtained from the GPS device 140 of FIG. 1. In another embodiment, the temperature distribution (and/or average temperature values) of step 306 is retrieved by the processor 154 of FIG. 1 from the memory 156 of FIG. 1 from stored values 166 pertaining to the geographic location data obtained from the GPS device 140 of FIG. 1. In yet another embodiment, the temperature distribution (and/or average temperature values) of step 306 is calculated by the processor 154 of FIG. 1 based on temperature values obtained from the temperature sensor 148 of FIG. 1.

A calendar capacity fade and resistance increase are then estimated (step 308). The calendar capacity fade and resistance increase are preferably estimated by the processor 154 of FIG. 1 based on the average values of steps 302-306.

In addition, an average temperature value is determined, preferably corresponding to an average temperature surrounding the battery (step 310). An average RMS power is also calculated, preferably corresponding to an average RMS power over various ignition cycles over time (step 311). An average state of charge (step 312), state of charge swing (step 314), and duty cycle (step 316) are also calculated or determined, preferably corresponding to respective values over various ignition cycles of the vehicle over time. The average values of steps 310-316 are preferably calculated by the processor 154 of FIG. 1 based on measurements provided thereto by the sensor array 142 of FIG. 1 (preferably from current and/or voltage values measured by one or more of the sensors 150, 152 of FIG. 1).

An estimated cycle capacity fade and resistance increase are then estimated (referenced in FIGS. 3 as a combined step 318). The cycle capacity fade and resistance increase are preferably estimated by the processor 154 of FIG. 1 based on the average values of steps 310-316. Finally, a combined battery life model current capacity, capacity fade, current resistance and resistance increase are then estimated (referenced in FIG. 3 as a combined step 320). The combined battery life model current capacity, capacity fade, current resistance and resistance increase are preferably estimated by the processor 154 of FIG. 1 using the intermediate values calculated in steps 308 and 310.

Returning to FIG. 2, a determination is made as to whether the battery life model current capacity is less than measured capacity of the battery and if the battery life model current resistance is greater than measured resistance of the battery (step 214). This determination is preferably made by the processor 154 based on calculations performed using measurements obtained from the sensor array 142 of FIG. 1. If it is determined that the battery life model current capacity is greater than or equal to the measured capacity of the battery or if the battery life model current resistance is less than or equal to the measured resistance of the battery, then the battery life fade ratio is set equal to one (step 216), preferably by the processor 154 of FIG. 1.

Conversely, if it is determined that the battery life model current capacity is less than the measured capacity of the battery or if the battery life model current resistance is more than the measured resistance of the battery, then the battery life fade ratio is calculated (step 216). During step 216, a battery life fade ratio is calculated based on an initial measured capacity (preferably, as measured by the sensor array 142 of FIG. 1 in step 204) and a battery life predicted capacity, and another battery life fade ratio is calculated based on an initial measured resistance and a battery life predicted resistance (preferably, as estimated by the processor 154 of FIG. 1 in step 212). Specifically, the battery life fade ratio is preferably calculated by the processor 154 of FIG. 1 in accordance with the following equation:

$$\begin{matrix}For capacity \text{:} & \\ \begin{matrix}B L F R C = ( min ( 1 , I M C ) - M C ) / \\ ( min ( 1 , I M C ) - B L M P C ) \\ = {Slope}_{measured} / {Slope}_{predicted} ,\end{matrix} & ( Equation 1 ) \\ For resistance \text{:} & \\ \begin{matrix}B L F R R = ( M R - max ( 1 , I M R ) ) / \\ ( B L M P R - max ( 1 , I M R ) ) \\ = {Slope}_{measured} / {Slope}_{predicted} ,\end{matrix} & ( Equation 2 )\end{matrix}$$

in which BLFRC represents the battery life fade ratio for capacity, BLFRR represents the battery life fade ratio for resistance, IMC represents the initial measured capacity, IMR represents the initial measured resistance, MC represents the measured capacity, MR represents the measured resistance, BLMPC represents the battery life model predicted capacity, BLMPR represents the battery life model predicted resistance, Slope_{measured} represents the measured slope, and Slope_{predicted} represents the predicted slope.

A predicted capacity function or curve and predicted resistance function or curve are then calculated (step 217). Specifically, the predicted capacity function or curve and predicted resistance function or curve are preferably calculated by the processor 154 of FIG. 1 using the battery life model of step 211, while using the current date and the current measured capacity and measured resistance of the battery (preferably as determined by the processor 154 of FIG. 1 using amp hour integration methods and open circuit voltage readings combined with a weighting system from the sensor array 142 of FIG. 1).

A determination is made as to whether the battery life fade ratios are greater than one (step 218). This determination is preferably made by the processor 154 of FIG. 1. This determination is used in calculating a modified, predicted capacity curve and a modified, predicted resistance curve in steps 219, 220, described directly below.

If it is determined in step 218 that the battery life fade ratio for capacity is greater than one, then the modified, predicted capacity curve is calculated (step 219). If it is determined in step 218 that the battery life fade ratio for resistance is greater than one, then the modified, predicted resistance curve is calculated (step 219). Specifically, the modified, predicted capacity curve and the modified, predicted resistance curve are preferably calculated in step 219 by the processor 154 of FIG. 1 in accordance with the following equations:

MPCC=1−(1−PCC)*BLFRC (Equation 3),

MPRC=1+(PRC−1)*BLFRR (Equation 4),

in which MPCC represents the modified, predicted capacity curve and MPRC represents the modified, predicted resistance curve calculated in step 219, PCC represents the predicted capacity curve and PRC represents the predicted resistance curve of step 217, and BLFRC and BLFRR represent the battery life fade ratios of step steps 215, 216.

Conversely, if it is determined in step 218 that the battery life fade ratio for capacity is less than or equal to one, then the modified, predicted capacity curve is set equal to the predicted capacity curve or if the battery life fade ratio for resistance is less than or equal to one, then the modified, predicted resistance curve is set equal to the predicted resistance curve of step 217 (step 220). The modified, predicted capacity curve and the modified, predicted resistance curve are preferably set in this manner by the processor 154 of FIG. 1.

A determination is made as to whether the modified, predicted capacity curve of steps 219, 220 is less than the battery life lower limit curve of step 211 at any point in time (step 221) or if the modified, predicted resistance curve of steps 219, 220 is greater than the battery life upper limit curve of step 211 at any point in time (step 221). This determination is preferably made by the processor 154 of FIG. 1. If it is determined in step 221 that the modified, predicted capacity curve of steps 219, 220 is less than the battery life lower limit curve of step 211 at any point in time and/or the modified, predicted resistance curve of steps 219, 220 is greater than the battery life upper limit curve of step 211 at any point in time, then the state of charge limits and power windows are closed by a calibratable amount (step 222). The state of charge limits and power windows are preferably closed by the processor 154 of FIG. 1.

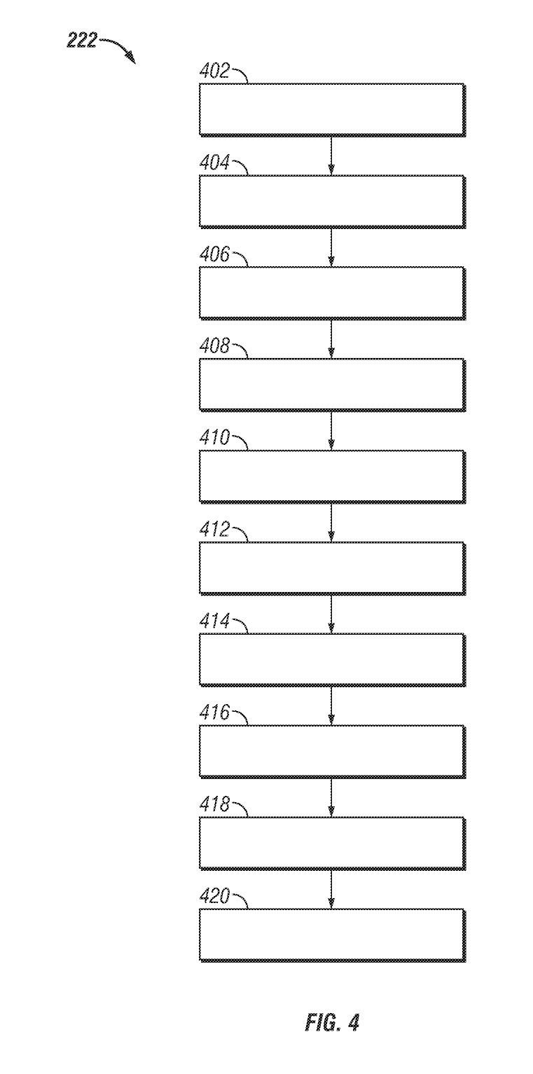

With reference to FIG. 4, an exemplary sub-process for step 222 of closing the state of charge limits and power windows is provided. As depicted in FIG. 4, the upper limit of the state of charge is decremented by a calibratable amount (step 402). In addition, the state of charge setpoint is also decremented by a calibrated amount (step 404). The lower limit of the state of charge is incremented by a calibratable amount (step 406). Each of the values of steps 402-406 are preferably calculated and/or implemented by the processor 154 of FIG. 1 and are not to exceed predetermined limits. In addition, the upper limit of step 402 is stored (preferably in the memory 156 of FIG. 1) as a temporary state of charge upper limit (step 408). Similarly, the setpoint of step 404 is stored (preferably in the memory 156 of FIG. 1) as a temporary state of charge setpoint (step 410), and the lower limit of step 406 is stored (preferably in the memory 156 of FIG. 1) as a temporary state of charge lower limit (step 412). In one embodiment, the rate of change might be on the order of a few percent (or percentage points) per month, and the adjustment might be on the order of a tenth of one percent. However, the values may vary, for example in different vehicles and/or applications.

In addition, in a preferred embodiment, an upper power limit of the battery is decremented by a calibratable amount (step 414). In addition, a lower power limit of the battery is incremented by a different calibratable amount (step 416). Each of the values of steps 414, 416 are preferably calculated and/or implemented by the processor 154 of FIG. 1 and are not to exceed predetermined limits. In addition, the upper limit of step 414 is stored (preferably in the memory 156 of FIG. 1) as a temporary upper power limit (step 418). Similarly, the lower limit of step 416 is stored (preferably in the memory 156 of FIG. 1) as a temporary lower power limit (step 420). In one embodiment, the rate of change might be on the order of a few percent (for example, three percent) of the initial power limit per month, which translates to approximately one kilowatt. Accordingly, in one embodiment, the daily adjustment may be on the order of a tenth of a percent, or 100 watts. However, the values may vary, for example, depending on the vehicle or application.

With reference again to FIG. 2, a determination is made as to whether the modified, predicted capacity curve of steps 219, 220 is greater than or less than the battery life lower limit curve of step 211 plus a predetermined deadband value or whether the modified, predicted resistance curve of steps 219, 220 is greater than or less than the battery life upper limit curve of step 211 minus a predetermined deadband value (step 224). In one embodiment, the deadband value is on the order of a few percentage points (for example, there percent). However, this may vary in other embodiments. This determination is preferably made by the processor 154 of FIG. 1. If it is determined in step 224 that the modified, predicted capacity curve of steps 219, 220 is greater than the battery life lower limit curve of step 211 plus the predetermined deadband value and/or the modified, predicted resistance curve of steps 219, 220 is less than the battery life upper limit curve of step 211 minus the predetermined deadband value then the state of charge and power windows are opened (step 225). The state of charge limits and power windows are preferably opened by the processor 154 of FIG. 1 and are not to exceed predetermined limits.

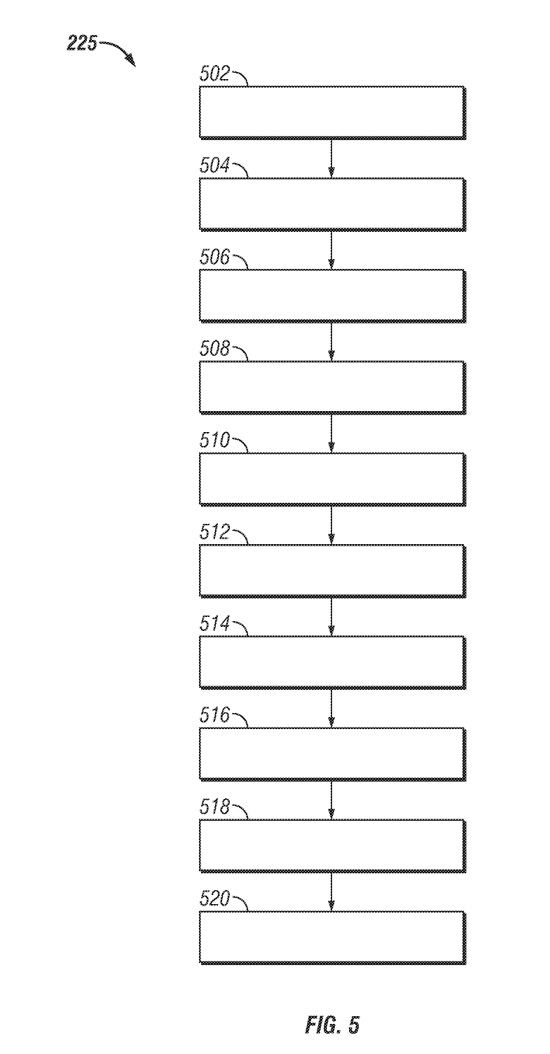

With reference to FIG. 5, an exemplary sub-process for step 225 of opening the state of charge limits and power windows is provided. As depicted in FIG. 5, the upper limit of the state of charge is incremented by a calibratable amount (step 502). In addition, the state of charge setpoint is also incremented by a calibrated amount (step 504). The lower limit of the state of charge is decremented by a calibratable amount (step 506). Each of the values of steps 502-506 are preferably calculated and/or implemented by the processor 154 of FIG. 1 and are not to exceed predetermined limits. In addition, the upper limit of step 502 is stored (preferably in the memory 156 of FIG. 1) as a temporary state of charge upper limit (step 508). Similarly, the setpoint of step 504 is stored (preferably in the memory 156 of FIG. 1) as a temporary state of charge setpoint (step 510), and the lower limit of step 506 is stored (preferably in the memory 156 of FIG. 1) as a temporary state of charge lower limit (step 512).

In addition, in a preferred embodiment, an upper power limit of the battery is incremented by a calibratable amount (step 514). In addition, a lower power limit of the battery is decremented by a different calibratable amount (step 516). Each of the values of steps 514, 516 are preferably calculated and/or implemented by the processor 154 of FIG. 1. In addition, the upper limit of step 514 is stored (preferably in the memory 156 of FIG. 1) as a temporary upper power limit (step 518). Similarly, the lower limit of step 516 is stored (preferably in the memory 156 of FIG. 1) as a temporary lower power limit (step 520).

With reference again to FIG. 2, the predicted capacity curve of step 217 and the predicted resistance curve are recalculated (step 226). Specifically, the predicted capacity curve and the predicted resistance curve are recalculated using the temporary state of charge upper limit, temporary state of charge lower limit, the temporary state of charge setpoint, the temporary power upper limit, and the temporary power lower limit. The predicted capacity curve and the predicted resistance curve are preferably recalculated by the processor 154 of FIG. 1 after retrieving these various values from the memory 156 of FIG. 1.

In addition, the modified, predicted capacity curve and the modified, predicted resistance curve of steps 219, 220 are also recalculated (step 228). Specifically, the modified, predicted capacity curve and the modified, predicted resistance curve are recalculated using the temporary state of charge upper limit, temporary state of charge lower limit, the temporary state of charge setpoint, the temporary power upper limit, and the temporary power lower limit. The modified, predicted capacity curve and the modified, predicted resistance curve are preferably recalculated by the processor 154 of FIG. 1 after retrieving these various values from the memory 156 of FIG. 1.

A determination is then made as to whether modified, predicted capacity curve is less than the battery life lower limit curve at any point and/or whether modified, predicted resistance curve is greater than the battery life upper limit curve at any point (step 230). This determination is preferably made by the processor 154 of FIG. 1. If it is determined in step 230 that the modified, predicted capacity curve is less than the battery life lower limit curve at any point and/or whether modified, predicted resistance curve is greater than the battery life upper limit curve at any point, then the state of charge limits are not adjusted, and the process exits (step 232). Conversely, if it is determined in step 230 that the modified, predicted capacity curve is greater than or equal to the battery life lower limit curve at every point and/or the modified, predicted resistance curve is less than the battery life upper limit curve at any point, then the process proceeds instead to step 234, described directly below.

During step 234, a determination is then made as to whether the modified, predicted capacity curve is greater than the battery life lower limit curve plus a deadband value at all points and/or whether modified, predicted resistance curve is less than the battery life upper limit curve minus a deadband value at any point. The deadband value preferably corresponds to the deadband value described above in connection with step 225. This determination is preferably made by the processor 154 of FIG. 1. If it is determined in step 234 that the modified, predicted capacity curve is greater than the battery life lower limit curve plus a deadband value at all points and/or whether modified, predicted resistance curve is less than the battery life upper limit curve minus a deadband value at any point, then the state of charge upper limit is set equal to the temporary state of charge upper limit (step 236), the state of charge lower limit is set equal to the temporary state of charge lower limit (step 238), and the state of charge setpoint is set equal to the temporary state of charge setpoint (step 240). In addition, under these conditions, the upper power limit of the battery is set equal to the temporary upper power limit (step 242), and the lower power limit is set equal to the temporary lower power limit (step 244).

Accordingly, the state of charge limits and power limits are increased when the vehicle has been operating in a relatively mild climate and/or with environmental and/or operating conditions that are conducive to longevity of the battery. Under such conditions, enhanced engine performance and fuel economy may be provided, while still maintaining at least an expected, predetermined battery life. Conversely, relatively more conservative state of charge limits and power limits are used when the vehicle has been operating in relatively hot climates and/or with environmental and/or operating conditions that are less conducive to longevity of the battery. Under such conditions, the battery state of charge and power settings are set so as to maximize battery life, to help ensure that at least an expected, predetermined battery life is attained even under such relatively adverse conditions.

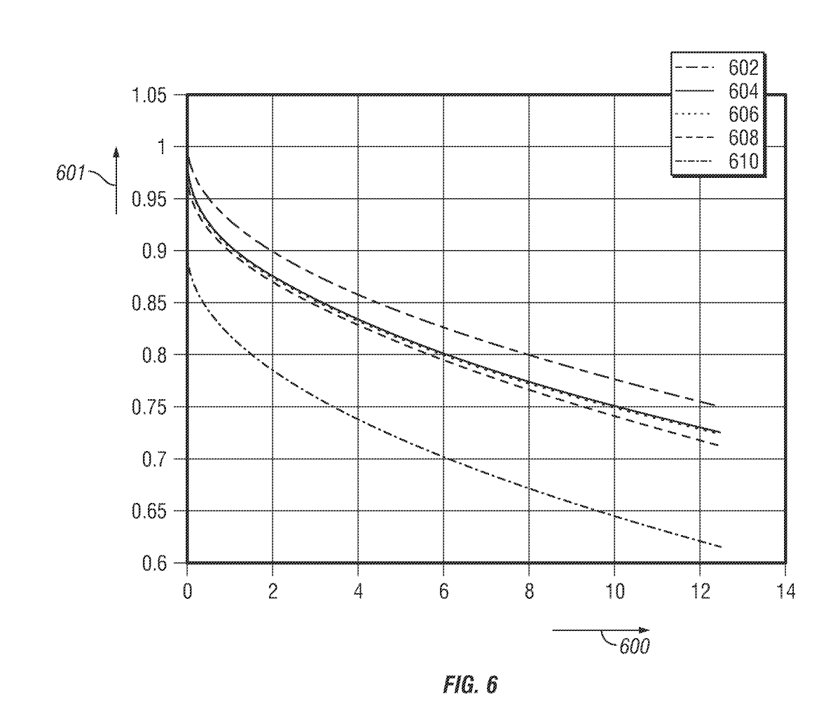

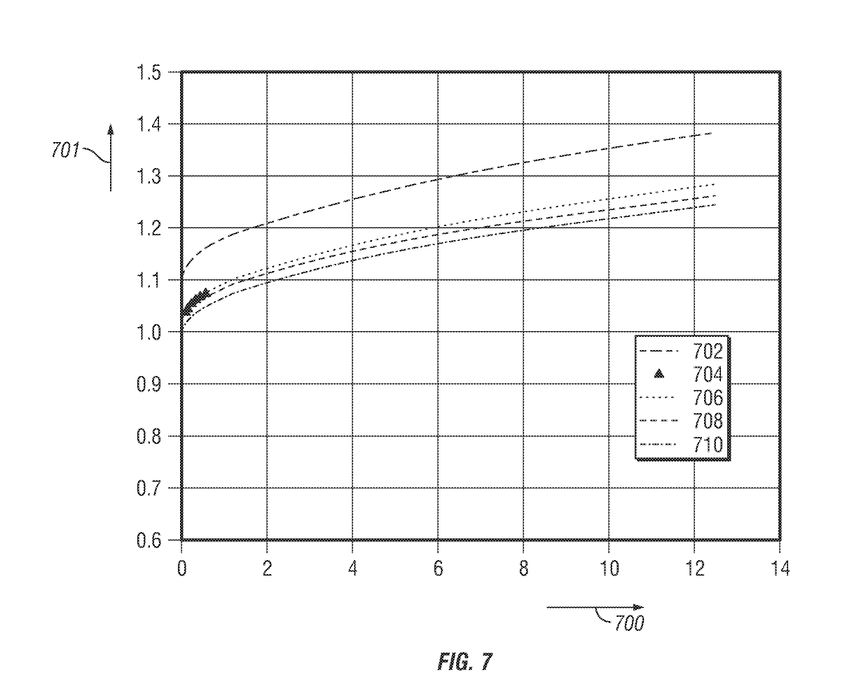

With reference to FIGS. 6 and 7, various exemplary graphical representations are provided to illustrate various curves and relationships of the process 200 described above in connection with FIGS. 2-5, and as implemented in connection with the vehicle 100, the battery 122, and the battery control system 124 of FIG. 1, in accordance with an exemplary embodiment. Specifically, FIG. 6 depicts (i) an exemplary predicted capacity curve 602 (corresponding to step 217 of FIG. 2); (ii) an exemplary measured capacity curve 604 (corresponding to step 204 of FIG. 2); (iii) an exemplary ratio 606 of the measured capacity curve 604 to the predicted capacity curve 602 (corresponding to steps 215, 216 of FIG. 2); (iv) an exemplary modified ratio 608 of the measured capacity curve 604 to the predicted capacity curve 602 (corresponding to steps 219, 220); and (v) a lower limit battery life curve 610 (corresponding to step 211 of FIG. 2). FIG. 6 includes an x-axis 600 with measurements in years, and a y-axis 601 with measurements in percent capacity.

In addition, FIG. 7 depicts (i) an exemplary predicted resistance curve 702 (corresponding to step 217 of FIG. 2); (ii) an exemplary measured resistance curve 704 (corresponding to step 204 of FIG. 2); (iii) an exemplary ratio 706 of the measured resistance curve 704 to the predicted resistance curve 702 (corresponding to steps 215, 216 of FIG. 2); (iv) an exemplary modified ratio 708 of the measured resistance curve 604 to the predicted resistance curve 702 (corresponding to steps 219, 220); and (v) a upper limit battery life curve 710 (corresponding to step 211 of FIG. 2). FIG. 7 includes an x-axis 700 with measurements in years, and a y-axis 701 with measurements in percent resistance.

The curves 602-610 of FIGS. 6 and 702-710 of FIG. 7 are utilized by the battery control system 124 of FIG. 1 and the process 200 (and sub-processes thereof) of FIGS. 2-4 in optimizing the state of charge limits (and preferably, also the power limits) of the battery. These limits are adjusted as appropriate in light of environmental and operating conditions (and preferably including geographic regions and temperature conditions pertaining thereto) in order to attain at least a predetermined number of years of battery life (which is set equal to approximately twelve years the exemplary embodiment of FIGS. 6 and 7, although this may vary in other embodiments). Within this framework, and so long as this minimum number of years are reasonably obtained, the state of charge and power limits may be optimized in mild conditions to provide optimized battery performance and fuel economy while still maintaining at least the desired minimum duration of battery life.

Accordingly, the systems, program products, and processes described above provide for potentially improved settings for state of charge and power limits for vehicle batteries. It will be appreciated that the disclosed systems, methods, and program products may vary from those depicted in the Figures and described herein. For example, the vehicle 100, the battery control system 124, and/or various components thereof may vary from that depicted in FIG. 1 and described in connection therewith. In addition, it will be appreciated that certain steps of the process 200 (and/or sub-processes and/or graphical representations pertaining thereto) may vary from those depicted in FIGS. 2-6 and/or described above in connection therewith. It will similarly be appreciated that certain steps of the processes and/or sub-processes described above may occur simultaneously or in a different order than that depicted in FIGS. 2-5 and/or described above in connection therewith. It will similarly be appreciated that the disclosed methods, systems, and program products may be implemented and/or utilized in connection with any number of different types of automobiles, sedans, sport utility vehicles, trucks, any of a number of other different types of vehicles. In addition, the disclosed systems, methods, and program products may also be utilized in connection with various other applications, such as stand-by power sources, for example for telecommunications or building back-up power.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof

We claim:

1. A method for calibrating limits of a battery of a vehicle, the battery having state of charge limits and power limits, the method comprising the steps of:
obtaining a history of environmental conditions for the vehicle; and
adjusting one or more of the state of charge limits, one or more of the power limits, or both, based on the history of environmental conditions using a processor.

2. The method of claim 1, further comprising the steps of:
measuring a current capacity and a current resistance of the battery using a sensor; and
estimating an expected capacity and expected resistance of the battery based on the history of environmental conditions and usage severity;
wherein the step of adjusting the one or more state of charge limits, the one or more power limits, or both, comprises the step of adjusting the one or more state of charge limits, power limits, or both based on a comparison of the current capacity to the expected capacity and the current resistance to the expected resistance.

3. The method of claim 2, further comprising the steps of:
estimating a rate of change of the current capacity;
estimating a rate of change of the expected capacity;
estimating a rate of change of the current resistance; and
estimating a rate of change of the expected resistance;
wherein the step of adjusting the one or more state of charge limits, power limits, or both comprises the step of adjusting the one or more state of charge limits, power limits, or both based on a ratio of the rate of change of the current capacity to the rate of change of the expected capacity, a ratio of the rate of change of the current resistance to the rate of change of the expected resistance, or both.

4. The method of claim 1, wherein:
the step of obtaining the history of environmental conditions comprises the step of determining a history of temperature conditions; and
the step of adjusting the one or more state of charge limits, power limits, or both comprises the step of adjusting the one or more state of charge limits, power limits, or both based on the history of temperature conditions and usage severity.

5. The method of claim 4, wherein the step of adjusting the one or more state of charge limits, power limits, or both comprises the step of:
establishing a first lower state of charge limit and a first upper state of charge limit if the history of temperature conditions represent an average temperature that is less than a first predetermined threshold; and
establishing a second lower state of charge limit and a second upper state of charge limit if the history of temperature conditions represent an average temperature that is greater than the first predetermined threshold, wherein the second lower state of charge limit is greater than the first lower state of charge limit and the second upper state of charge limit is greater than the first upper state of charge limit.

6. The method of claim 4, wherein the step of obtaining the history of temperature conditions comprises the steps of:
measuring ambient temperature values for the battery during operation of the vehicle over time via a sensor; and
storing the ambient temperature values in a memory.

7. The method of claim 4, wherein the step of obtaining the history of temperature conditions comprises the steps of:
receiving geographic data as to one or more geographic locations of the vehicle via a global positioning system device; and
obtaining temperature data pertaining to temperatures associated with the one or more geographic locations.

8. A program product for calibrating limits of a battery of a vehicle, the battery having state of charge limits and power limits, the program product comprising:
a program configured to:
obtain a history of environmental conditions for the vehicle; and
adjust one or more of the state of the charge limits, one or more of the power limits, or both based on the history of environmental conditions; and
a non-transitory, computer-readable storage medium bearing the program.

9. The program product of claim 8, wherein the program is further configured to:
obtain a measurement as to a current capacity and resistance of the battery;
estimate an expected capacity and resistance of the battery based on the history of environmental conditions; and
adjust the one or more state of charge limits, power limits, or both based on a comparison of the current capacity, expected capacity, current resistance and expected resistance.

10. The program product of claim 9, wherein the program is further configured to:
estimate a rate of change of the current capacity;
estimate a rate of change of the expected capacity;
estimate a rate of change of the current resistance;
estimate a rate of change of the expected resistance; and
adjust the one or more state of charge limits, power limits, or both based on a ratio of the rate of change of the current capacity to the rate of change of the expected capacity, a ratio of the rate of change of the current resistance to the rate of change of the expected resistance, or both

11. The program product of claim 8, wherein the program is further configured to:
determine a history of temperature conditions; and
adjust the one or more state of charge limits, power limits, or both based on the history of temperature conditions.

12. The program product of claim 11, wherein the program is further configured to:
establish a first lower state of charge limit and a first upper state of charge limit if the history of temperature conditions represent an average temperature that is less than a first predetermined threshold; and
establish a second lower state of charge limit and a second upper state of charge limit if the history of temperature conditions represent an average temperature that is greater than the first predetermined threshold, wherein the second lower state of charge limit is greater than the first lower state of charge limit and the second upper state of charge limit is greater than the first upper state of charge limit.

13. The program product of claim 11, wherein the program is further configured to:
receive measurements of ambient temperature values for the battery during operation of the vehicle over time; and
store the ambient temperature values in a memory for subsequent use in adjusting the one or more state of charge limits, power limits, or both.

14. The program product of claim 11, wherein the program is further configured to:
receive geographic data as to one or more geographic locations of the vehicle via a global positioning system device; and
obtain temperature data pertaining to temperatures associated with the one or more geographic locations.

15. A system for calibrating limits of a battery of a vehicle, the battery having state of charge limits and power limits, the system comprising:
a memory configured to store a history of environmental conditions for the vehicle; and
a processor coupled to the memory and configured to adjust one or more of the state of charge limits, one or more of the power limits, or both based on the history of environmental conditions and usage severity.

16. The system of claim 15, further comprising:
a sensor to measure a current value, a voltage value, or both, of the battery for use in a sensor-based algorithm for determining a current capacity and a current resistance of the battery;
wherein the processor is coupled to the sensor and to the sensor-based algorithm and is configured to:
estimate an expected capacity and expected resistance of the battery based on the history of environmental conditions; and
adjust the one or more state of charge limits, power limits, or both based on a comparison of the current capacity to the expected capacity, a comparison of the current resistance to the expected resistance, or both.

17. The system of claim 16, wherein the processor is further configured to:
estimate a rate of change of the current capacity;
estimate a rate of change of the expected capacity;
estimate a rate of change of the current resistance;
estimate a rate of change of the expected resistance; and
adjust the one or more state of charge limits, power limits, or both based on a ratio of the rate of change of the current capacity to the rate of change of the expected capacity, a ratio of the rate of change of the current resistance to the rate of change of the expected resistance.

18. The system of claim 15, wherein:
the history of environmental conditions comprises a history of temperature conditions; and
the processor is further configured to:
establish a first lower state of charge limit and a first upper state of charge limit if the history of temperature conditions represent an average temperature that is less severe than a first predetermined threshold; and
establish a second lower state of charge limit and a second upper state of charge limit if the history of temperature conditions represent an average temperature that is greater than the first predetermined threshold, wherein the second lower state of charge limit is greater than the first lower state of charge limit and the second upper state of charge limit is greater than the first upper state of charge limit.

19. The system of claim 15, further comprising:
a sensor configured to measure ambient temperature values for the battery during operation of the vehicle over time for storage in the memory and for use in adjusting the one or more state of charge limits, power limits, or both.

20. The system of claim 15, further comprising:
a global positioning system device configured to provide geographic data as to one or more geographic locations of the vehicle;
wherein the processor is coupled to the global positioning system device and is further configured to obtain temperature data pertaining to temperatures associated with the one or more geographic locations.
